(19) United States
(12) Patent Application Publication
(10) Pub. No.: US 2025/0132495 A1
(43) Pub. Date: Apr. 24, 2025

(54) SINGLE FEEDER MULTI-FREQUENCY ANTENNA

(71) Applicant: PLUME DESIGN, INC., Palo Alto, CA (US)

(72) Inventors: Miroslav SAMARDZIJA, Mountain View, CA (US); Arthur TUNG, San Jose, CA (US); Yu Ching CHU, Hsinchu County (TW); Yun-Ping HUANG, Santa Clara, CA (US); Liem Hieu Dinh VO, San Jose, CA (US)

(21) Appl. No.: 18/913,295

(22) Filed: Oct. 11, 2024

Related U.S. Application Data
(60) Provisional application No. 63/591,193, filed on Oct. 18, 2023.

(51) Int. Cl. H01Q 5/378; H01Q 9/04; H01Q 19/00

(52) U.S. Cl. CPC H01Q 5/378; H01Q 9/0414; H01Q 19/005

(57) ABSTRACT

The disclosure describes an antenna that is formed from a continuous material according to some embodiments. In some embodiments, the antenna includes a plurality of individual antenna modules each formed from the continuous material. In some embodiments, each antenna module is configured to resonate at a plurality of frequencies. In some embodiments, each antenna module is configured to receive a voltage and/or current from a single feeder. In some embodiments, each of the antenna modules are effectively electrically isolated from each other. In some embodiments, each antenna module includes one or more driven portions and one or more parasitic portions. In some embodiments, the one or more driven portions are configured and/or arranged to induce a voltage in the one or more parasitic portions.

### CROSS REFERENCE TO RELATED APPLICATION

This patent application claims the benefit of U.S. Provisional Application No. 63/591,193, filed Oct. 18, 2023, which is incorporated by reference herein in its entirety.

### FIELD OF THE DISCLOSURE

The present disclosure is generally related to antennas, and more particularly, to an antenna that includes a plurality of individual antenna modules that each are configured to resonate at multiple frequencies while coupled to a single feeder.

### SUMMARY OF THE DISCLOSURE

Antennas typically require the most volume in a consumer electronic (e.g., smart phone) device. There are multiple reasons for the large amount of space an antenna requires. First, antenna size is proportional to wavelength of operation (inversely proportional to frequency). For example, at 2.4 Hz WiFi, the wavelength is about 120 mm, requiring the antenna to be typically at least equal or larger than the quarter wavelength (30 mm at 2.4 GHz). Second, most consumer electronic devices (e.g., smart home devices) have multiple antennas. A typical smart router may have 10 or more antennas (e.g., 2 for 2.4 GHz, 4 for 5 GHz, and 4 for 6 GHz WiFi). In addition, the router may have antennas for IoT (e.g., Bluetooth® (BT), Matter®, ZigBee®, UWB, etc), as well as cellular back-up antennas in case of ISP/CSP outages. Third, all of these antennas need to be separated to provide isolation for interference-free operation. Antennas require clearance in the product in order to assure antennas operate as intended and that they do not couple to nearby components/parts (e.g., a chip, PA, LNA, fan, FEM, PCB). Fourth, service loops and volumes need to be created for installation/assembly of all of these antennas. This volume will only be used once during manufacturing and is “waisted” for the rest of product life-time.

Therefore, there is a need in the art for an antenna that can resonate at multiple frequencies via current supplied by a single feeder to reduce complexity and save space.

In some embodiments, the disclosure is directed to an antenna, where at least a portion of the antenna is formed from a single continuous material. In some embodiments, continuous material includes a single sheet of metal, or block of plastic, as non-limiting examples. In some embodiments, the antenna module includes a printed circuit board (PCB). In some embodiments, the antenna module includes one or more spreader structures.

As discussed herein, a spreader structure (or “spreader,” used interchangeably) is a component designed to support and separate the antenna's radiating elements or elements of an array. According to some embodiments, a spreader can help maintain the desired physical spacing and orientation between these elements to optimize the antenna's performance. Spreaders are commonly used in applications, such as, for example, antennas, dipole antennas, and other array configurations to ensure that the radiating elements are properly positioned and maintain their relative distances. This spacing is crucial for achieving the desired radiation pattern and impedance characteristics of the antenna. Spreaders can be made of various materials, such as plastic, fiberglass, or metal, depending on the antenna's design and application.

In some embodiments, the antenna includes a plurality of antennas modules. In some embodiments, one or more of the plurality of antennas modules do not include antenna feed cables (i.e., no non-integral feeding structure attached) making a formed antenna a stand-alone continuous piece of rigid material. In some embodiments, each antenna module includes a single feeder (e.g., cable, feedline, projection) configured to induce a voltage in each of the plurality of antenna modules.

In some embodiments, according to a method of manufacture, the antenna is configured to be assembled automatically without need for extra volume. In some embodiments, at least a portion of the antenna includes one or more radiating structures (e.g., elements). Available volume is used most efficiently, as at least a portion of each antenna module is integrated into the one or more spreader structures to create the radiating structures according to some embodiments. In some embodiments, the radiating structures include, driven, parasitic, and/or slot type radiating structures.

In some embodiments, the antenna module includes one or more parasitic elements to support multi-band operations (e.g., 2.4, 5, and 6 GHz). In some embodiments, the one or more parasitic antennas do not comprise a feedline. In some embodiments, one or more parasitic antennas are configured to generate current through induced voltage from a proximate radiating structure (e.g., driven element). In some embodiments, the proximate radiating structure is electrically coupled to a single feedline. This improvement over conventional antennas allows for electrically isolated parasitic elements (antennas) integral to the antenna module to be powered without the use of a feedline. In some embodiments, the novel antenna modules described herein enable a smaller antenna area and/or volume. For example, a quarter wavelength antenna element (30 mm at 2.4 GHz) can be shrunk to half when using parasitic antennas as described herein according to some e embodiments.

In some embodiments, one or more antennas formed by one or more antenna module configurations include an internal fractal antenna (IFA) and/or a planar inverted-f antenna (PIFA). In some embodiments, IFA and PIFA antennas are used in electronic devices such as smartphones. In some embodiments, these antennas offer good impedance matching and radiation patterns while fitting within the limited space of a device's casing. In some embodiments, IFA antennas formed according to the methods described herein include fractal geometries to enhance performance and bandwidth.

In some embodiments, one or more antennas include open-slot antennas. Open-slot antennas are characterized by a slot or gap in a conducting surface, such as a metal plate. Open-slot antennas radiate electromagnetic waves through the open slot, and their properties are influenced by the slot dimensions. In some embodiments, open-slot antennas can be designed for various frequency bands for microwave and wireless communication systems.

In some embodiments, one or more antennas include slot antennas. In some embodiments, slot antennas are similar to open-slot antennas but can be standalone structures or integrated into larger systems. In some embodiments, the open-slot antennas include a narrow slit or opening in a conducting surface, which acts as a radiating element. In some embodiments, slot antennas applications include radar and satellite communications.

In some embodiments, one or more antennas include Patch antennas. In some embodiments, patch antennas, also known as microstrip antennas, include flat, planar antennas. In some embodiments, they consist of a radiating patch, usually square, rectangular, or circular in shape, and are backed by a ground plane. In some embodiments, patch antennas are commonly used in applications like Wi-Fi, GPS, and RFID.

The shape and type of antenna that can be fabricated according to the systems and methods described herein are not limited to the antenna types described above or below. In general, the term radiating antenna, driven antenna, parasitic antennas, and/or any other type of antenna described herein (which may also be referred to as a portion or element) can be shaped from a continuous material to achieve desired radiation pattern and frequency characteristics for a particular application. In some embodiments, the continuous material comprises a same material (e.g., metal composition) throughout the entire antenna structure. In some embodiments, a feedline in combination with one or more shorts, one or more driven elements, and one or more parasitic elements, one or more carrier portions, and one or more grounds form one or more antennas, as is described in more detail below.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 shows an antenna assembly according to some embodiments.

FIG. 2 shows a first and second view of the antenna carrier according to some embodiments.

FIG. 3 depicts a cut antenna and a formed antenna according to some embodiments.

FIG. 4 highlights three antenna elements that are discussed further with regard to FIGS. 5-12.

FIG. 5 depicts a zoomed view of antenna module 314 according to some embodiments.

FIG. 6 shows a simplified wiring diagram of a non-limiting example antenna module according to some embodiments.

FIG. 7 illustrates the shape of one or more portions of the antenna module forming an open slot antenna 700 according to some embodiments.

FIG. 8 depicts one or more portions of the antenna module forming a first driven element antenna 800 according to some embodiments.

FIG. 9 illustrates a second driven antenna according to some embodiments.

FIG. 10 shows the activation of the first parasitic element to create a first parasitic antenna 1000 according to some embodiments.

FIG. 11 shows the activation of the second parasitic element to create a second parasitic antenna according to some embodiments.

FIG. 12 illustrates a slot antenna formed by physically bridging the first driven element 621 and the second parasitic element according to some embodiments.

FIG. 13 depicts a frequency chart showing resonance frequencies received from a single feed antenna module according to some embodiments.

FIG. 14 highlights antenna modules according to some embodiments.

FIG. 15 shows an open slot antenna formed by at least a portion of the antenna 101 and the carrier.

FIG. 16 shows a slot antenna which is a first variation of an antenna module where an additional slot has been added to tune the slot antenna for a different frequency according to some embodiments.

FIG. 17 shows multiple side views of an antenna assembly according to some embodiments.

FIG. 18 illustrates the first heat spreader shown in FIG. 17 being modified to include a first peninsula type projection along the open slot current path according to some embodiments.

FIG. 19 shows a first heat spreader comprising a second peninsula type projection according to some embodiments.

FIG. 20 shows a first heat spreader comprising a single top gap between the ground portion and a top portion of the projection, where an entire length of the bottom portion of the projection is in contact with the RF board according to some embodiments.

FIG. 21 illustrates using a combination of slots formed in the first heat spreader and one or more elements of an antenna module to obtain resonance at a particular frequency.

FIG. 22 shows a first heat spreader comprising a single top gap between the ground portion and a top portion of the projection, where an entire length of the bottom portion of the projection is in contact with the RF board according to some embodiments.

FIG. 23 shows another antenna module and heat spreader configuration according to some embodiments.

FIG. 24 shows yet another antenna module and heat spreader configuration according to some embodiments.

FIG. 25 shows still another antenna module and heat spreader configuration according to some embodiments.

FIG. 26 illustrates a method of manufacture for adding one or more bridges between a driven element and a parasitic element according to some embodiments.

FIG. 27 depicts a zoomed view of FIG. 26 according to some embodiments.

FIG. 28 illustrates a method of manufacture that includes welding a bridge between a first driven element and a first parasitic element.

FIG. 29 depicts the electrical field forming a slot antenna as a result of the formed bridge and the welded bridge according to some embodiments.

FIG. 30 shows an alternate configuration for antenna modules according to some embodiments.

FIG. 31 shows a zoomed view of antenna module 3014 in a non-limiting example according to some embodiments.

FIG. 32 illustrates the current path (dashed arrow) along a parasitic element for a non-limiting example configuration according to some embodiments.

FIG. 33 illustrates the current path (dashed arrow) induced by a driven portion along a parasitic portion for another non-limiting example configuration according to some embodiments.

FIG. 34 shows yet another antenna module configuration according to some embodiments.

FIG. 35 illustrates forming a projection and/or a fold on a second driven element projecting from a first driven element according to some embodiments.

FIG. 36 illustrates various antenna configurations with various projections, folds, recess, and/or slots according to some embodiments.

FIG. 37 illustrates a method of manufacture for forming a gap in one or more elements for a fastener while still providing desirable frequency resonance according to some embodiments.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed.

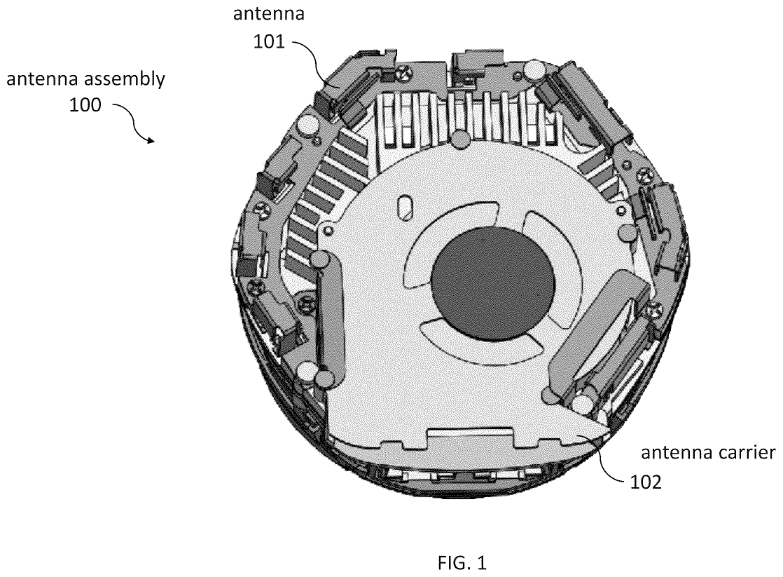

FIG. 1 shows an antenna assembly 100 according to some embodiments. In some embodiments, the antenna assembly 100 includes an antenna 101 and an antenna carrier 102. In some embodiments, the antenna carrier includes one or more heat spreaders. In some embodiments, one or more head spreaders include conductive material configured to distribute and/or dissipate heat. In some embodiments, the antenna carrier 102 includes a radio frequency (RF) board, which may include a printed circuit board (PCB). Further details of the interaction of the carrier with one or more antenna modules are further described below.

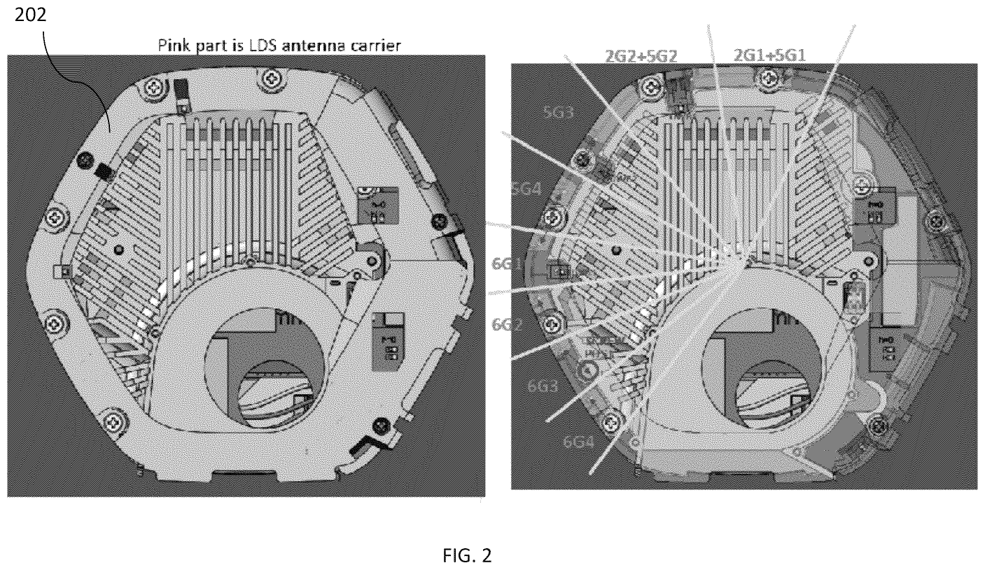

FIG. 2 shows a first and second view of the antenna carrier according to some embodiments. As illustrated in FIG. 2, item 202 corresponds to the laser direct structuring (LDS), as discussed herein. Accordingly, the depicted view provides mechanisms for communications occurring between the device via antenna components, layers and/or modules, as discussed herein.

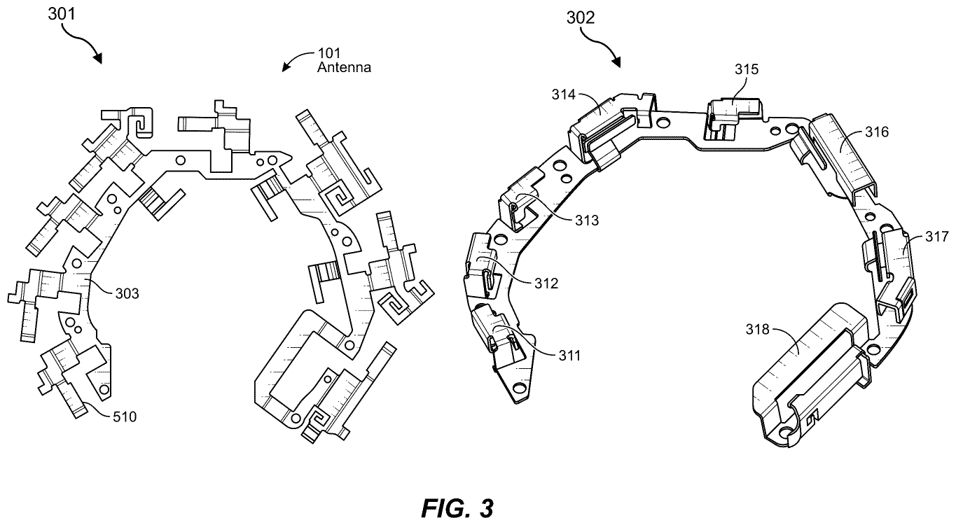

FIG. 3 depicts a cut antenna 301 and a formed antenna 302 according to some embodiments. According to a method of manufacture, the antenna is formed by removing material (e.g., making cuts) in a continuous material to form the shapes for a plurality of antenna modules 311-318. In some embodiments, the continuous material 303 includes a substantially flat continuous material at a pre-forming manufacturing step. In some embodiments, a method step includes shaping and/or forming the continuous material 303 by folding and/or not folding one or more continuous material 303 portions to form each of the plurality of antenna modules 311-318, resulting in a formed antenna 302. In some embodiments, the formed antenna 302 is shaped by one or more of a layering process, an LDS process, and an etching process.

In some embodiments, a step includes shaping (e.g., folding and/or not folding) at least a portion of the continuous material 303 such that the at least a portion forms a feeder 510 configured to form an electrical connection with the antenna carrier 101. In some embodiments, a step includes shaping at least a portion of the continuous material to form a ground portion 540 configured to form an electrical ground with the antenna carrier 101. In some embodiments, a step includes folding at least a portion of the continuous material to form a driven portion 520 configured to receive a directly supplied electrical current. In some embodiments, a step includes folding at least a portion of the continuous material 303 such that the at least a portion forms a parasitic portion 530 configured to receive electrical voltage indirectly.

In some embodiments, indirectly generated voltage includes electrical current generated by induction from a driven portion 520 proximate the parasitic portion 530. In some embodiments, a step includes folding at least a portion of the continuous material 303 such that the at least a portion forms a plurality of individual antenna modules 311-318. In some embodiments, each of the plurality of antenna modules 311-318 comprises one or more of a single feed 510, at least one driven portion 520, and at least one parasitic portion 530. In some embodiments, one or more driven portions 520 are each configured to receive and/or resonate at a plurality of frequencies. In some embodiments, the parasitic portion 530 is configured to operate as a director. In some embodiments, the parasitic portion 530 is configured to operate as a reflector. In some embodiments, the parasitic portion 530 is configured to resonate at a different frequency than the driven portion 520, forming its own antenna. In some embodiments, the parasitic portion 530 is configured to increase the bandwidth of at least one frequency of the driven portion 520.

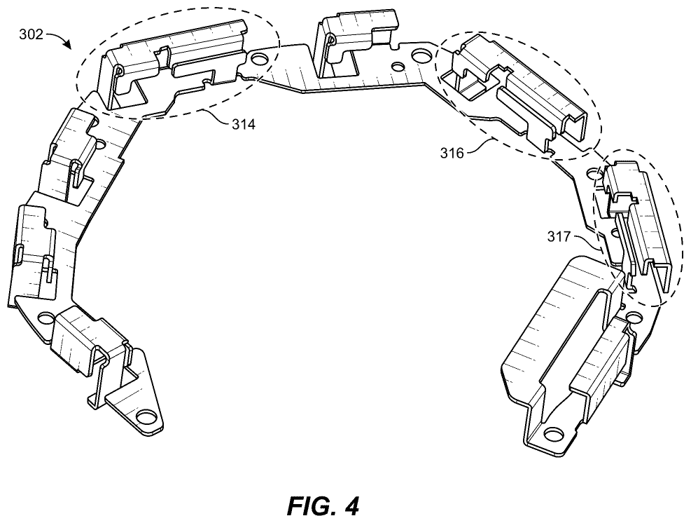

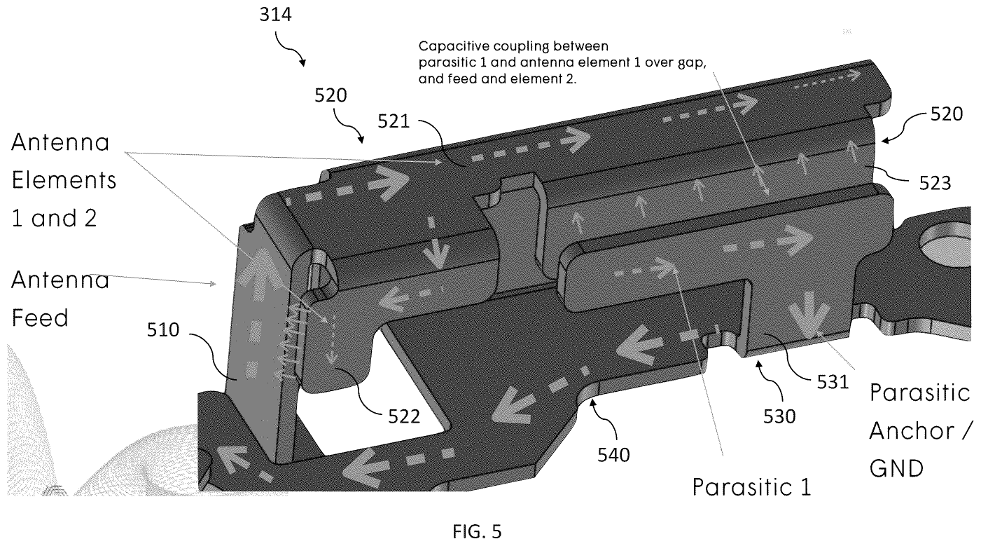

In some embodiments, each antenna module 311-318 integral to the formed antenna 302 is configured to function separately, where each separate antenna module 311-318 is configured to receive a plurality of frequencies. FIG. 4 highlights three antenna elements 314, 316, and 317 that are discussed further with regard to FIGS. 5-12. FIG. 5 depicts a zoomed view of antenna module 314 according to some embodiments.

In some embodiments, each one or more antenna modules 311-318 include a driven portion 520 and one or more parasitic portions 530. In some embodiments, the driven portion includes one or more driven elements 521, 522, In some embodiments, each driven element 521, 522 is formed such that they resonate at different frequencies while receiving the same input voltage from a feeder 510, which is also formed from the continuous material 303 in some embodiments. In some embodiments, the dashed arrows represent direction and current flow (larger represents more current) and the solid arrows indicate induction between elements. In some embodiments, the different shape of each driven element 521, 522 results in a different effective length through which current flows allowing resonance at different frequencies. In some embodiments, first driven clement 521 is configured to resonate at a different frequency than a second driven element 522. In some embodiments, the second driven clement 522 is formed from a projection of the continuous material 303 extending from the first driven element 521. In some embodiments, a first driven clement 521 is configured and arranged to induce a voltage in a second driven element 510, where the second driven element includes the feeder 510.

In some embodiments, a parasitic portion 530 is configured to have a voltage induced by a driven portion 520 of an antenna module 314. In some embodiments, the driven portion 520 includes one or more induction projections 523. In some embodiments, one or more induction projections 523 include and/or project from at least a portion of a driven element 521 as described above. In some embodiments, this can be part of the driven element(s), for induction and/or can be configured such that its shape can impact frequency. In some embodiments, one or more induction projections 523 do not include a driven element and/or are not configured to act as a driven element (i.e., receive and/or enhance a specific wavelength). In some embodiments, the parasitic portion 531 is positioned within the antenna module 314 (316, 317) to interact with the electromagnetic fields generated by driven portion 520 (e.g., induction projection 523) to achieve specific antenna characteristics.

In some embodiments, at least a portion of the driven portion 520 is directly connected (e.g., by feeder 510) to an RF signal and/or voltage source. The driven portion 520, which may include the feeder 510, is configured to emit or receive electromagnetic energy (e.g., RF signals) according to some embodiments. In some embodiments, parasitic portions 530 include and/or are formed from at least a portion of the continuous material 303. In some embodiments, one or more parasitic portions 530 are directly coupled to a ground portion 540 of the continuous material. In some embodiments, one or more parasitic portions 530 are at least partially electrically isolated from the feeder 510 (i.e., no active signal connection) by the ground portion 540, and/or do not receive or transmit signals without receiving an induced voltage from a driven portion 520.

In some embodiments, one or more parasitic portions 530 interact with the electromagnetic fields generated by the driven portion 520. In some embodiments, the proximity and electrical characteristics of a parasitic element 531 cause electromagnetic coupling with a driven element 521, affecting the driven element's radiation pattern and properties. In some embodiments, the presence of one or more parasitic elements 531 alters the radiation pattern of the one or more driven elements 521, 531. In some embodiments, by strategically positioning a parasitic element 531 in relation to a driven element 521, it is possible to achieve specific antenna characteristics, such as increased directivity and gain. In some embodiments, this allows for better control over the direction in which the driven element 521 sends and/or receives signals. In some embodiments, the one or more parasitic elements 531 are configured to receive one or more frequency bands, which may be achieved during manufacture by a step of adjusting the shape (e.g., projections, recesses, slots) and or dimensions (e.g., length, width, height) of a parasitic element 531. In some embodiments, changing the spacing and dimensions of a parasitic element 531 in relation to a driven clement 521 allows for frequency tuning.

In some embodiments, one or more parasitic elements 531 are configured to resonate at a different frequency than one or more driven elements 521, 522. In some embodiments, one or more parasitic elements 531 are configured to receive a different RF frequency than a driven element 521, 522. In some embodiments, one or more parasitic portions 530 are configured to cause a gain increase of the driven element 521. In some embodiments, one or more parasitic elements 531 are configured to increase directionality of a driven element 521. In some embodiments, one or more parasitic elements 531 are configured to increase the bandwidth of a driven element 531.

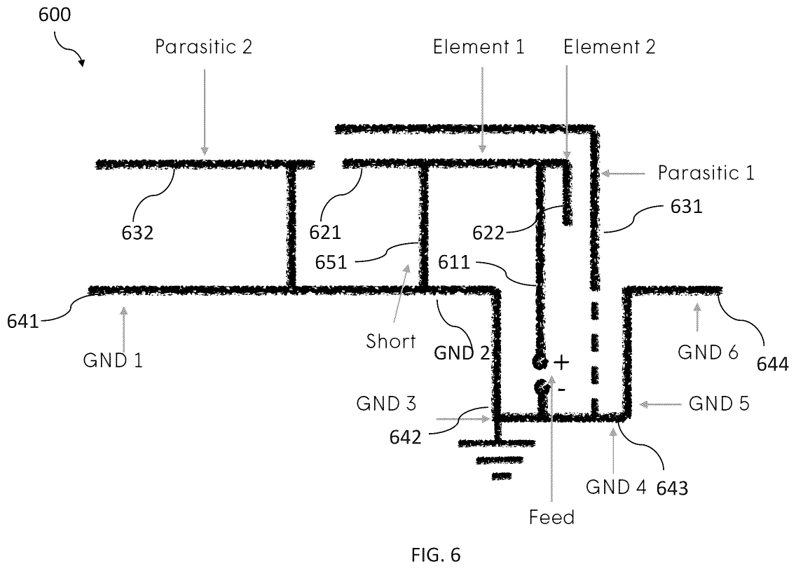

FIG. 6 shows a simplified wiring diagram of a non-limiting example antenna module 600 according to some embodiments. While various driven and parasitic element arrangements and configurations are presented herein, the types of interactions between the driven elements and the parasitic elements of one or more antenna modules are described with reference to FIGS. 6-12. In some embodiments, one or more of the effects described with regard to FIGS. 6-12 occur (substantially) simultaneously within an antenna module, enabling resonance at multiple frequencies in a continuous structure powered by a single feeder 611.

As shown in FIG. 6, the antenna module 600 includes a feeder 611, one or more driven elements 621, 622, one or more parasitic elements 631, 632, one or more grounds (GND) 641-644, and/or one or more shorts 651. In some embodiments, one, a portion or all of the grounds can be connected and/or grouped to produce a single ground (e.g., utilize GND 3). In some embodiments, GND 1, 2, 3, etc, includes any continuous shape. In some embodiments, each driven element 621, 622 includes any shape. In some embodiments, one or more driven elements 621, 622 and/or one or more combination of driven elements 621, 622 are configured to operate at one band (e.g., BT/2.4 GHz) and/or multiple bands (e.g., BT/2.4 GHz/5 GHz/6 GHz). In some embodiments, one or more parasitic elements 631, 632 project from one or more grounds 641-644 and do not physically touch a driven element 621, 622. In some embodiments, one or more parasitic elements 631, 632 are configured to generate single and/or multiple band frequencies. In some embodiments, one or more parasitic elements 631, 632 are configured to generate single and/or multiple band frequencies in combination with one or more driven elements 621, 622. In some embodiments, the feeder 611, one or more driven elements 621, 622, one or more parasitic elements 631, 632, one or more shorts 651, and/or a combination thereof, forms one or more of IFA, PIFA, Open-Slot, Slot, and Patch type antennas.

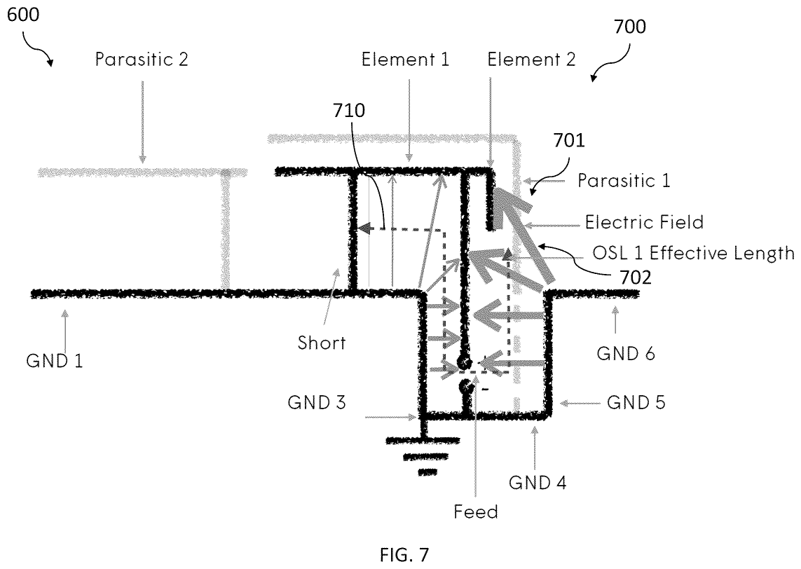

FIG. 7 illustrates the shape of one or more portions of the antenna module 600 forming an open slot antenna 700 according to some embodiments. In some embodiments, the open slot (or gap) in one or more conducting surfaces are configured to receive an electromagnetic signal through a phenomenon known as slot coupling. Slot coupling occurs when electromagnetic waves impinge on the slot, inducing currents along the edges of the slot and leading to the reception of the signal. In some embodiments, when electromagnetic waves, such as radio waves, approach a conducting surface with an open slot or gap, a portion of these waves enters the gap. As the electromagnetic waves enter the slot, in some embodiments they create an electric field across the gap. In some embodiments, this electric field induces currents along the edges of the slot. In some embodiments, these currents are driven by the voltage differences caused by the incident waves. The efficiency and effectiveness of slot coupling depend on various factors, including the size and geometry of the slot, the frequency of the incident waves, and the characteristics of the surrounding materials according to some embodiments.

In some embodiments, the induced currents along the slot's edges can be tapped into and extracted as a received signal via the feeder. In some embodiments, the antenna assembly includes one or more computers comprising one or more processors and one or more non-transitory computer readable media. In some embodiments, the one or more non-transitory computer readable media include program instructions stored thereon that enable the one or more computers, via the one or more processors, to implement one or more program steps. In some embodiments, a step includes to receive one or more signals from one or more antenna modules. In some embodiments, a step includes to process the signals and extract resonant frequencies from the one or more signals, wherein the processed signal can be configured to be utilized by the connected electronic circuitry or antenna system.

Referring back to FIG. 7, in some embodiments, open-slot-like (OSL) radiation is dominated by the electric field (arrows) across the slot 701. In some embodiments, the electric field component of the electromagnetic wave generated by the antenna is more significant in the direction across the slot compared to other directions, where the primary direction of radiation is across the slot, and/or where the electric field is more pronounced in this direction. In some embodiments, the electrical field is weakest (thin arrows) and/or shorted at an edge of a slot. In some embodiments, the electric field is strongest at the open end 702 of the slot 701. In some embodiments, the open slot antenna effective length 710 is less than quarter wavelength at frequency of operation. In some embodiments, increasing a width of the OSL shortens the length, where the width of the OSL includes the gap across which electric field is spread, shown as solid arrows in FIG. 7. In some embodiments, one or more open slot antennas formed within an antenna module 600 are configured to excite 5 GHz and/or 6 GHz WiFi, and/or Ultra-wide Band (UWB) as non-limiting examples according to some embodiments. In some embodiments, at 5 GHz, the effective length is approximately 20-30 mm.

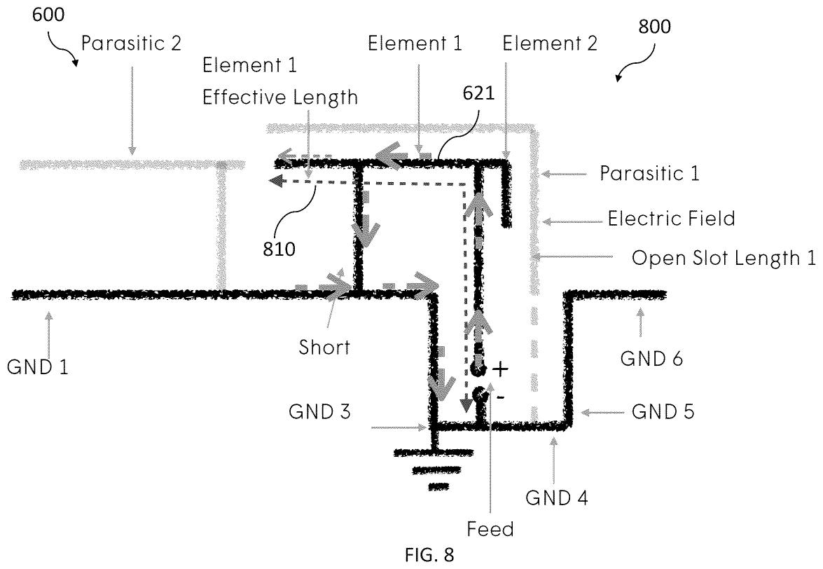

FIG. 8 depicts one or more portions of the antenna module 600 forming a first driven clement antenna 800 according to some embodiments. In some embodiments, the antenna can be, but is not limited to, a wire, aperture, loop, and the like. In some embodiments, a first element 621's radiation is dominated by electric current (dashed arrows). In some embodiments, the first element 621's effective length 810 is shorter than a quarter wavelength at a frequency of operation when made a 2D or 3D. In some embodiments, the effective length 810 is reduced by introducing width and height to the first element 621. In some embodiments, the first driven element antenna 800 can be used to excite a first frequency (e.g., 5 GHz, 6 GHz WiFi, UWB, 2.4 GHz/BT). In some embodiments, at 5 GHz the effective length is approximately 20-30 mm.

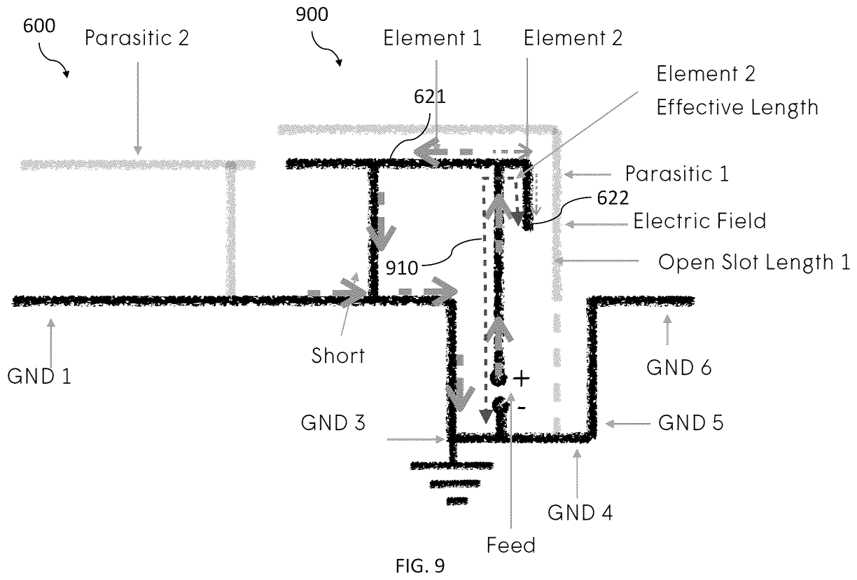

FIG. 9 illustrates a second driven antenna 900 according to some embodiments. In some embodiments, a second driven clement 622 projection from a portion of the first driven element 621 is configured to create a second effective length 910 to excite a second frequency different from the first frequency (at least a threshold amount of value). In some embodiments, the antenna module is configured to resonate at the first frequency and second frequency simultaneously. In some embodiments, a second element 622's radiation is dominated by electric current (dashed arrows). In some embodiments, the second element 622's effective length 910 is shorter than a quarter wavelength at a frequency of operation when made a 2D or 3D shape. In some embodiments, the effective length 910 is reduced by introducing width and height to the second driven element 622. In some embodiments, the second driven element antenna 800 can be used to excite a second frequency (e.g., 5 GHz, 6 GHz WiFi, UWB, 2.4 GHz/BT). In some embodiments, at 5 GHz the effective length 910 is approximately 20-30 mm.

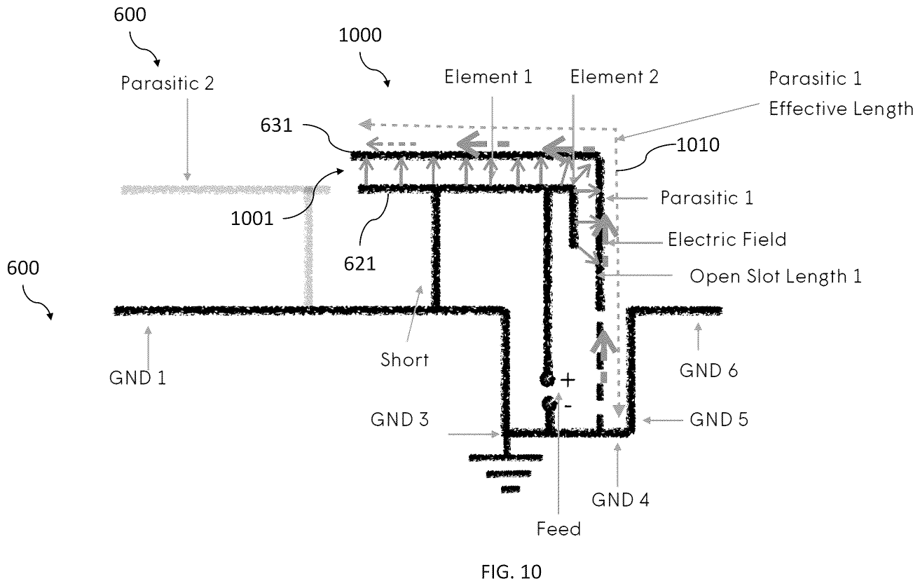

FIG. 10 shows the activation of the first parasitic element 631 to create a first parasitic antenna 1000 according to some embodiments. In some embodiments, the first parasitic element 631 is configured to be electrically coupled to the first driven element 621 and/or the second driven clement 622 via induction by an electric field (solid arrows) across a gap 1001. In some embodiments, driven element 1's resonating can cause an effect on voltage; and in some embodiments, such resonating can impact frequency reception in parasitic 1. In some embodiments, first parasitic 631 radiation is dominated by the currents flowing on the first parasitic element 631. In some embodiments, the first parasitic element's effective length 1010 is shorter than a quarter wavelength at a frequency of operation when made a 2D or 3D. In some embodiments, the effective length 1010 is reduced by introducing width and height to the first parasitic clement 631. In some embodiments, the first parasitic element antenna 1000 can be used to excite a third frequency (e.g., 5 GHz, 6 GHz WiFi, UWB, 2.4 GHz/BT). In some embodiments, a combination of the first driven element 621 and/or the second driven element 622, along with the second parasitic element 632, where the second parasitic clement 632 is separated by the gap 1101, is configured to excite a different frequency than each element would produce individually. In some embodiments, a combination of the first driven clement 621 and/or the second driven element 622 along with the second parasitic element 632, separated by the gap 1001, is configured to excite 2.4 GHz/BT (Bluetooth®).

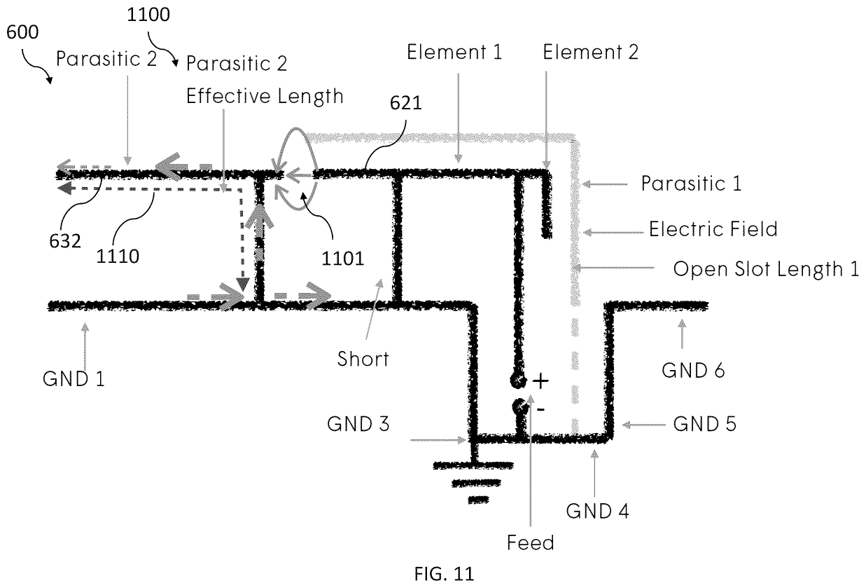

FIG. 11 shows the activation of the second parasitic element 632 to create a second parasitic antenna 1100 according to some embodiments. In some embodiments, the second parasitic element 632 is configured to be electrically coupled to the first element 621 via induction across a gap 1101. In some embodiments, the second parasitic's radiation is dominated by the currents flowing on the second parasitic element 632. In some embodiments, the second parasitic element's effective length 1110 is shorter than a quarter wavelength at a frequency of operation when made a 2D or 3D. In some embodiments, the effective length 1110 is reduced by introducing width and height to the second parasitic clement 632. In some embodiments, the second parasitic element antenna 1100 can be used to excite a fourth frequency (e.g., 5 GHz WiFi, 6 GHz WiFi, UWB, 2.4 GHz/BT). In some embodiments, the fourth frequency is dependent on the size of the gap 1101 between the first driven element 621 and the second parasitic clement 632. In some embodiments, a combination of the first driven element 621 and the second parasitic element 632, separated by the gap 1101, is configured to excite a different frequency than each element would produce individually. In some embodiments, a combination of the first driven element 321 and the second parasitic clement 632, separated by the gap 1101, is configured to excite 2.4 GHz/BT.

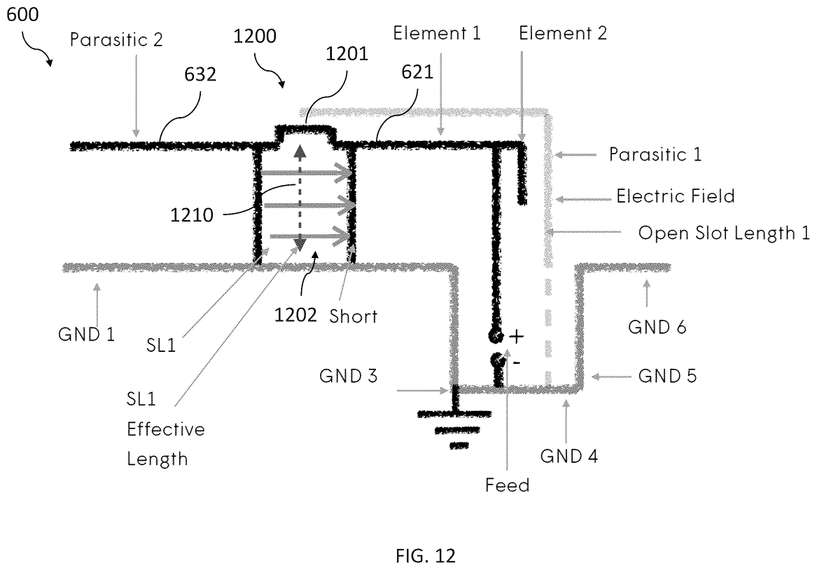

FIG. 12 illustrates a slot antenna 1200 formed by physically bridging the first driven clement 621 and the second parasitic element 632 according to some embodiments. In some embodiments, the first driven clement 621 and the second parasitic clement 632 are connected (DC to DC-for example, to convert voltages via, in some embodiments, a DC converter) by bridge 1201 to form a slot like radiating structure (SL). In some embodiments, the slot antenna's radiation is dominated by an electric field (solid arrows) over the gap 1202. In some embodiments, the slot antenna's effective length 1210 is shorter than a quarter wavelength at a frequency of operation when made 2D or 3D. In some embodiments, the effective length 1210 is reduced by introducing width and height to one or more elements described herein. In some embodiments, the one or more slot antennas on an antenna module are configured to excite a fifth frequency. In some embodiments, a fifth frequency includes one or more of 5 GHz WiFi, 6 GHz WiFi, and UWB.

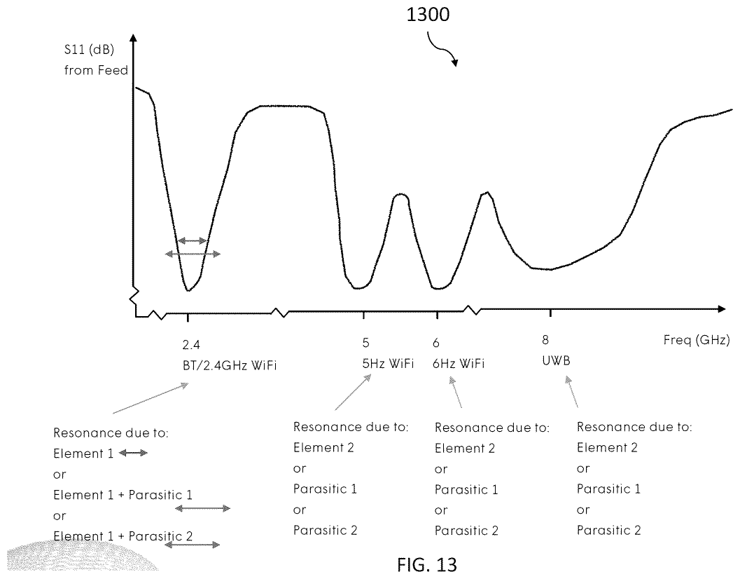

FIG. 13 depicts a frequency chart 1300 showing resonance frequencies received from a single feed of antenna module 600 according to some embodiments. In some embodiments, resonance at 2.4 GHz (BT, WiFi) is the result of current in the first driven element 621. In some embodiments, a combination of the signal received from the first driven element and the first parasitic clement is configured to broaden a bandwidth (longer arrow). In some embodiments, a combination of the signal received from the first driven element 621, the first parasitic element 631, and/or the second parasitic element 632 is configured to broaden a bandwidth. As shown in FIG. 13, a combination of the first driven element 621 and the first parasitic element 631 and/or second parasitic element 632 is configured to broaden the bandwidth at 2.4 GHz. In some embodiments, the frequency chart 1300 also shows a resonance at 5 GHz, 6 GHz, and 8 GHz (UWB). In some embodiments, resonance at 5 GHz, 6 GHz, and 8 GHz (UWB) come from one or more of the second clement, the first parasitic, and/or the second parasitic in this non-limiting example.

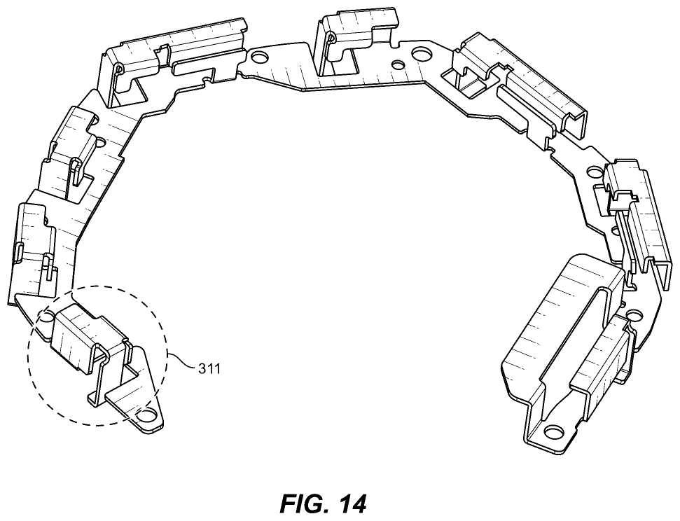

FIG. 14 highlights antenna module 311 according to some embodiments. The principles and arrangements of antenna module 311, including the use of the carrier 102 as a portion of an antenna, can be applied to any antenna module according to some embodiments. In some embodiments, at least a portion of the carrier 102 forms a circuit length for creating one or more antennas.

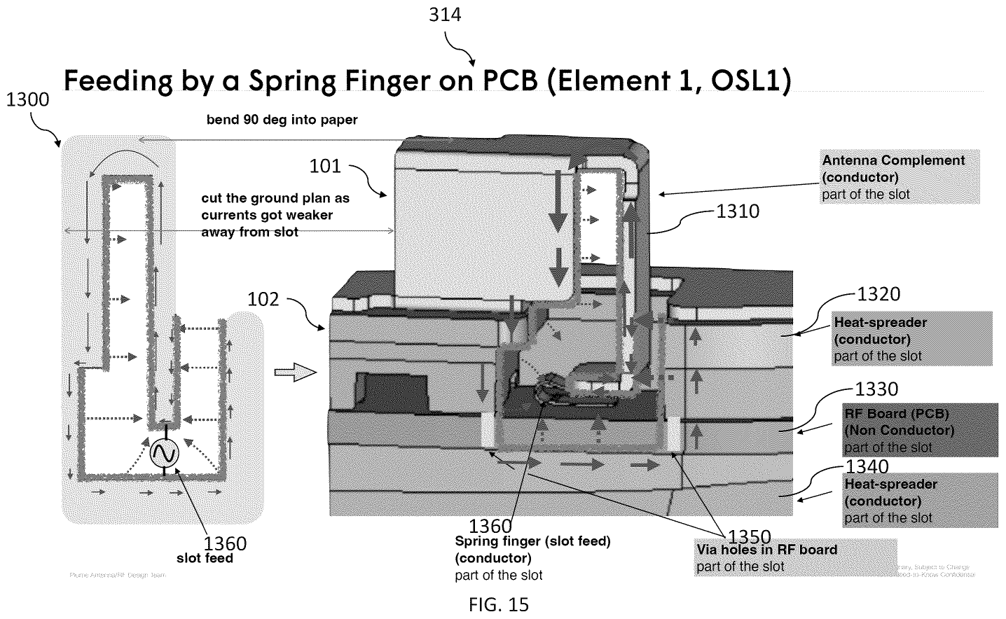

FIG. 15 shows an open slot antenna 1300 formed by at least a portion of the antenna 101 and the carrier 102. As shown in FIG. 15, in some embodiments, a first heat spreader 1320 (e.g., heat exchanger) is configured to be in direct contact with and/or directly coupled to the antenna module 314. In some embodiments, the RF board 1330 is configured to be in direct contact with and/or directly coupled to the first heat spreader 1320. In some embodiments, the RF board 1330 is configured to be in direct contact with and/or directly coupled to a second heat spreader 1340. In some embodiments, the carrier 102 comprises a stack which includes a first heat spreader 1320 below the antenna 101, an RF board 1330 below the first heat spreader 1320, and a second heat spreader 1340 below the RF board 1330. In some embodiments, a horizontal plane of the antenna 101 which passes through all antenna elements defines a top portion of the antenna assembly.

In some embodiments, current supplied from feeder 1310 via spring finger 1360, which is controlled by one or more program instructions as described above, is configured to flow through one or more (all in this non-limiting example) of the antenna module 314 (conductive material), the first heat spreader 1320 (conductive material), the RF board 1330 (non-conductive material), and the second head spreader 1340 (conductive material). In some embodiments, via holes 1350, including a conductive element, which can be configured to carry the current across RF board 1330.

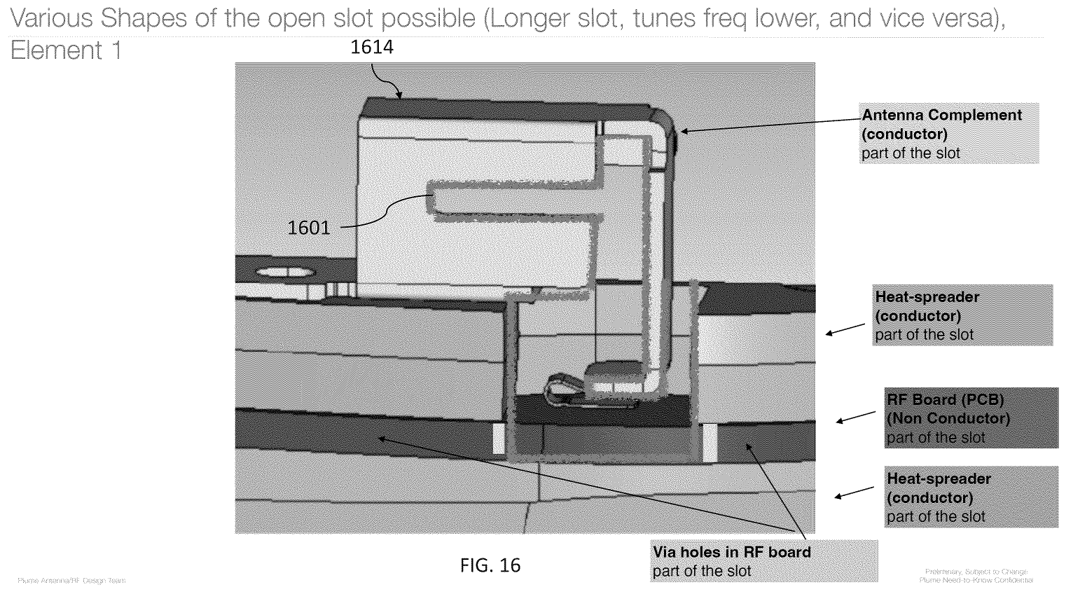

FIG. 16 shows a slot antenna 1614 which is a first variation of antenna module 314 where an additional slot 1601 has been added to tune the slot antenna for a different frequency according to some embodiments. It should be understood that while various configurations presented herein may have novel shapes, the principle of shaping an antenna module and/or an antenna and antenna carrier to achieve a particular frequency resonance applies to all configurations described herein.

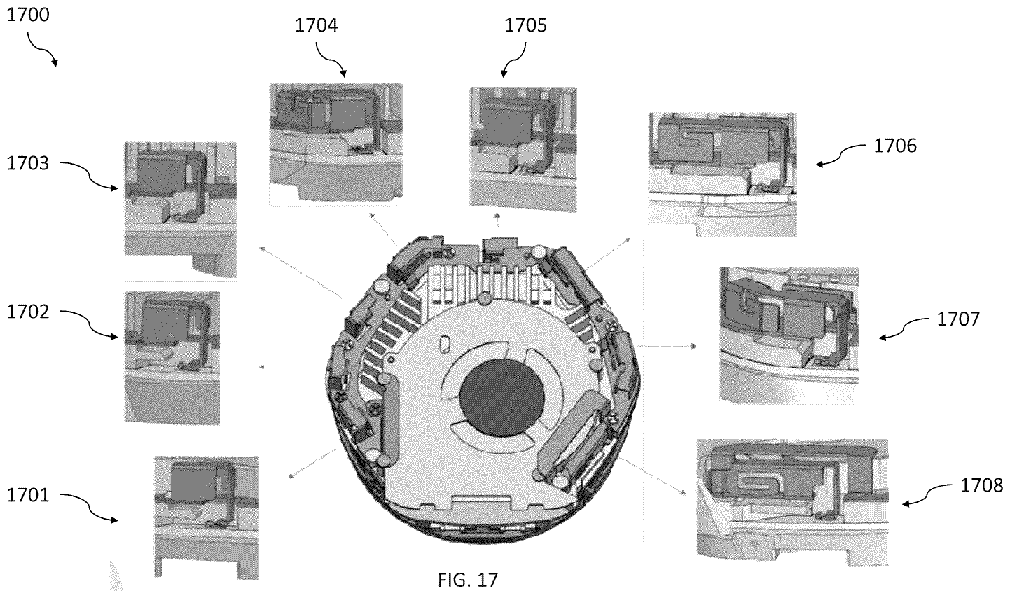

FIG. 17 shows multiple side views 1701-1708 of an antenna assembly 100 according to some embodiments. In some embodiments, one or more antennas are tuned by forming one or more slots, projections, and/or recesses in at least a portion of a first heat spreader.

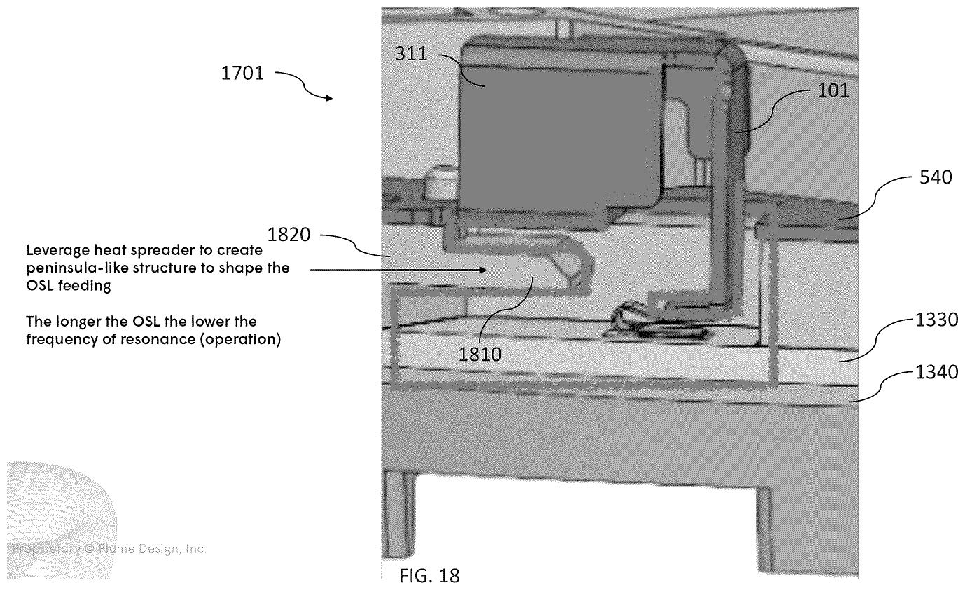

FIG. 18 illustrates the first heat spreader 1820 shown in FIG. 17 being modified to include a first peninsula type projection 1810 along the open slot current path (emphasized) according to some embodiments. In some embodiments, the projection 1810 includes a horizontal projection including a gap formed between a ground portion 540 of the antenna 101 and a top portion of the projection 1810. In some embodiments, the projection 1810 includes a gap formed between a bottom portion of the projection 1810 and the RF board 1330. In some embodiments, the projection 1810 is configured to increase the current path for the OSL. In some embodiments, the longer the OSL, the lower the frequency of resonance at operation.

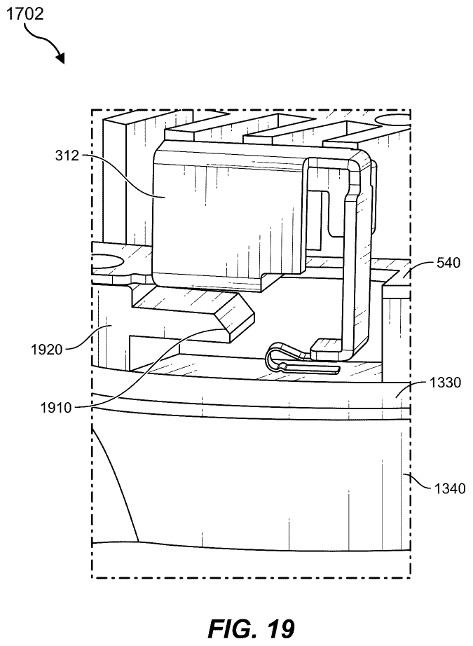

FIG. 19 shows a first heat spreader 1920 comprising a second peninsula type projection 1910 according to some embodiments. In some embodiments, the gap along the bottom portion of the projection 1910 is smaller (less volume, parameter length) enabling a shorter current path according to some embodiments.

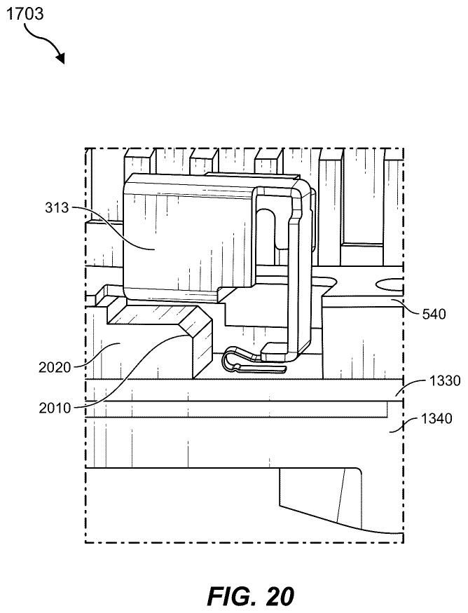

FIG. 20 shows a first heat spreader 2020 comprising a single top gap between the ground portion 540 and a top portion of the projection 2010, where an entire length of the bottom portion of the projection 2010 is in contact with the RF board 1330 according to some embodiments.

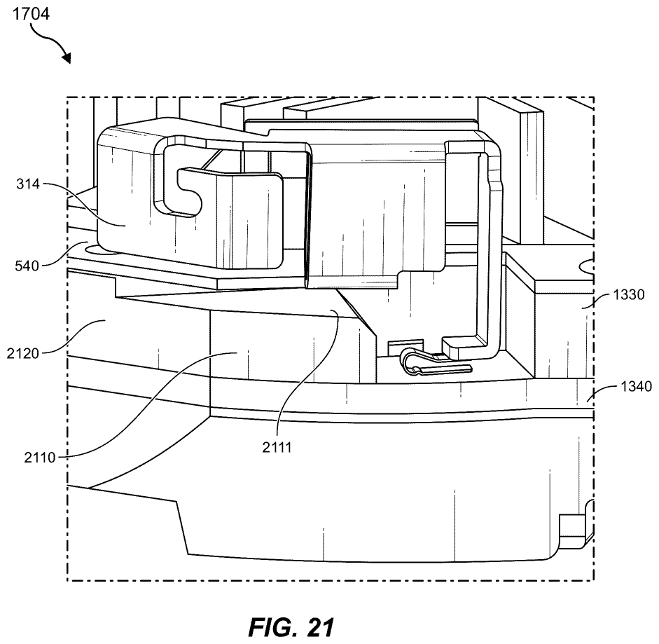

FIG. 21 illustrates using a combination of one or more slots formed in the first heat spreader 2120 projection 2110 and one or more elements of antenna module 314 to obtain resonance at a particular frequency. In some embodiments, the projection 2110 includes a curved shape and/or an extended top gap 2111 to achieve a particular resonance.

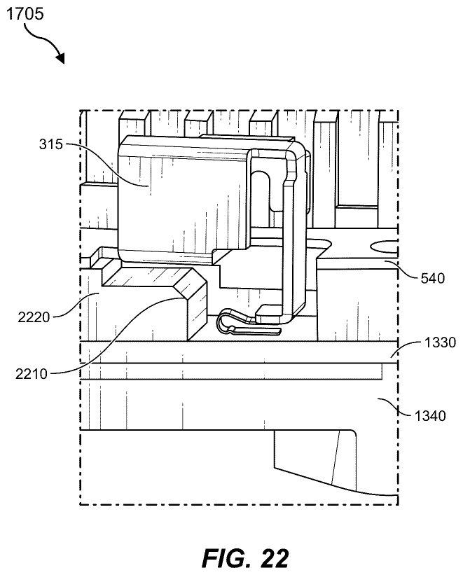

FIG. 22 shows a first heat spreader 2220 comprising a single top gap between the ground portion 540 and a top portion of the projection 2210, where an entire length of the bottom portion of the projection 2210 is in contact with the RF board 1330 according to some embodiments. In some embodiments, the antenna 101 is configured to have multiple substantially similar antenna modules in order to achieve certain functionality.

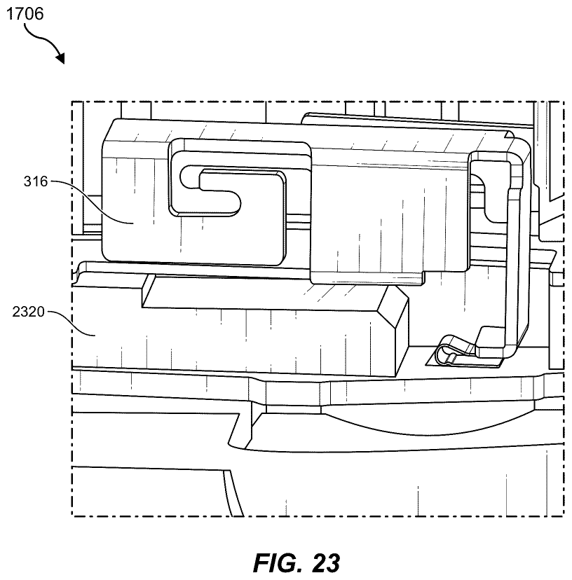

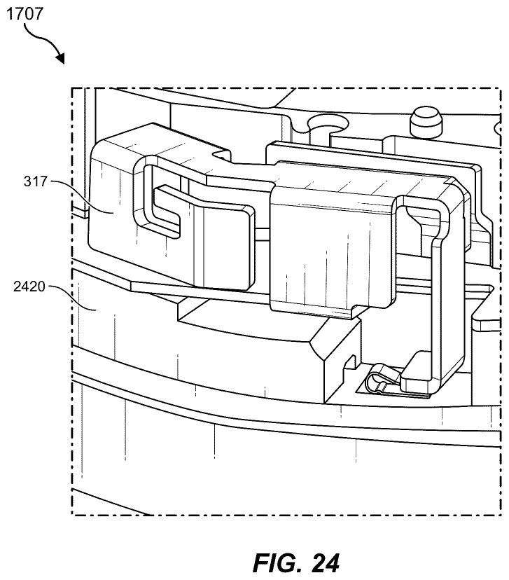

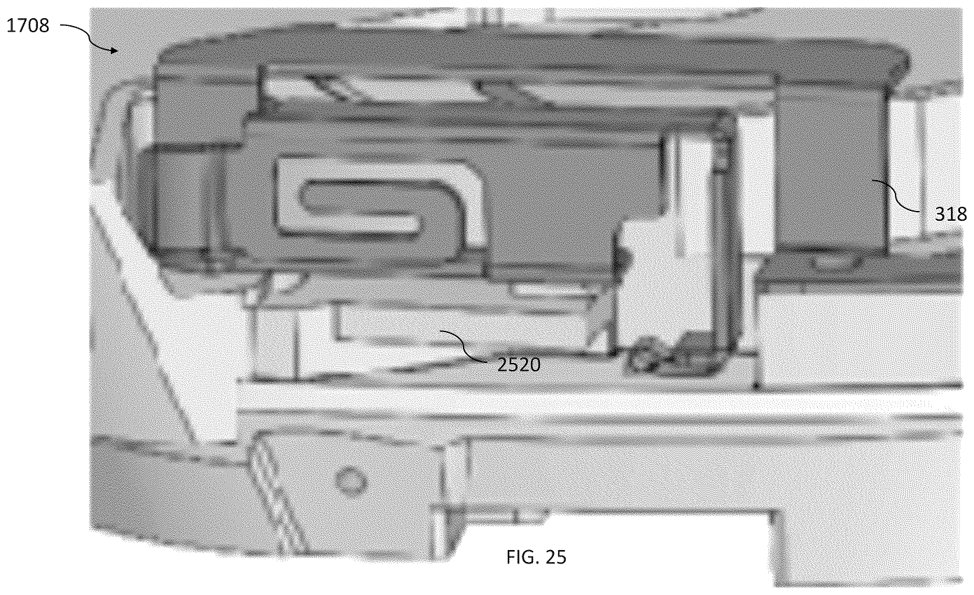

FIG. 23 shows another antenna module 316 and heat spreader 2320 configuration according to some embodiments. FIG. 24 shows yet another antenna module 317 and heat spreader 2420 configuration according to some embodiments. FIG. 25 shows still another antenna module 318 and heat spreader 2520 configuration according to some embodiments.

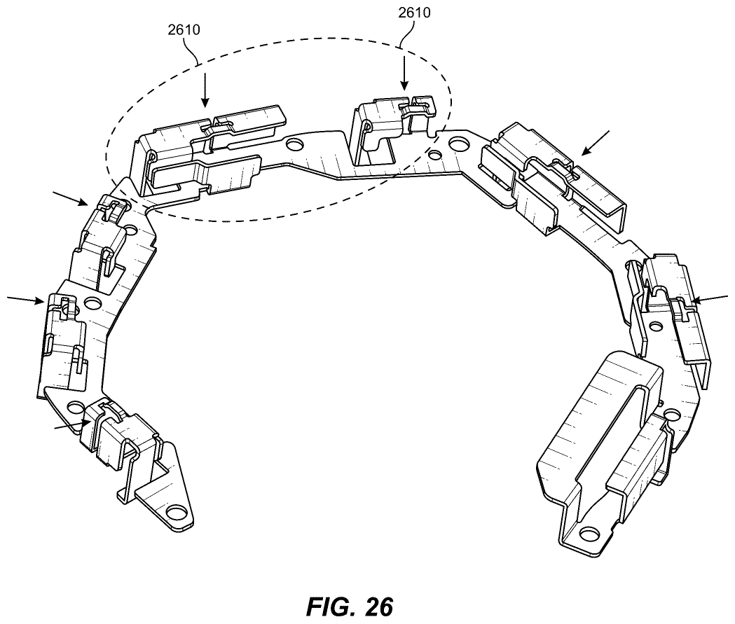

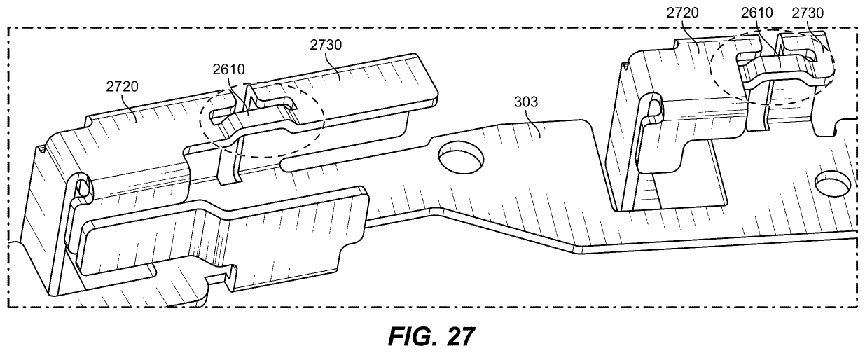

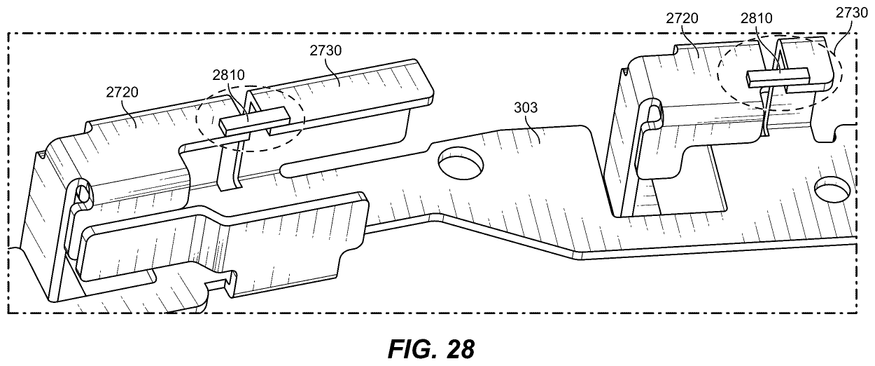

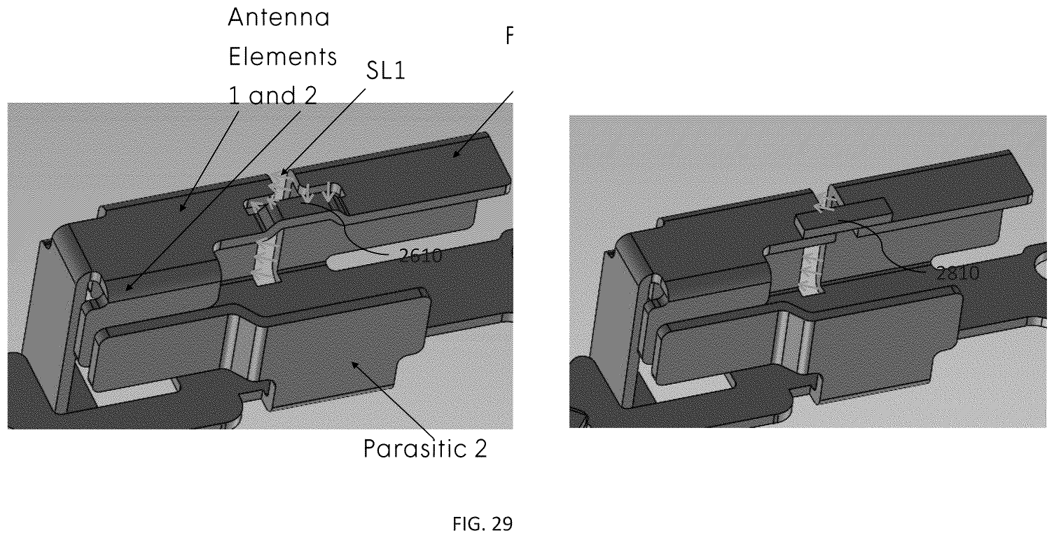

FIG. 26 illustrates a method of manufacture for adding one or more bridges 2610 between a driven element 2720 and a parasitic element 2730 according to some embodiments. FIG. 27 depicts a zoomed view of FIG. 26 according to some embodiments. In some embodiments, the method of manufacture includes cutting and/or forming one or more bridges 2610 from the continuous material 303. FIG. 28 illustrates a method of manufacture that includes welding a bridge 2810 between a first driven element 2720 and a first parasitic element 2730. In some embodiments, welding has the advantage of being able to modify one or more antenna modules of an already formed antenna 101 to achieve desired resonance characteristics. In some embodiments, once a bridge is formed, a parasitic clement can be utilized as a driven element. FIG. 29 depicts the electrical field (arrows) forming a slot antenna as a result of the formed bridge 2610 and the welded bridge 2810 according to some embodiments. In some embodiments, such welding and/or formation can create a different resonance profile.

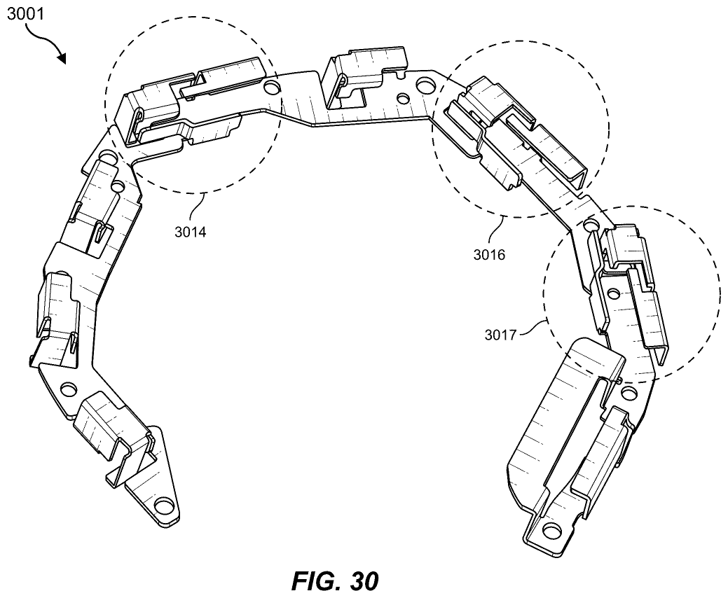

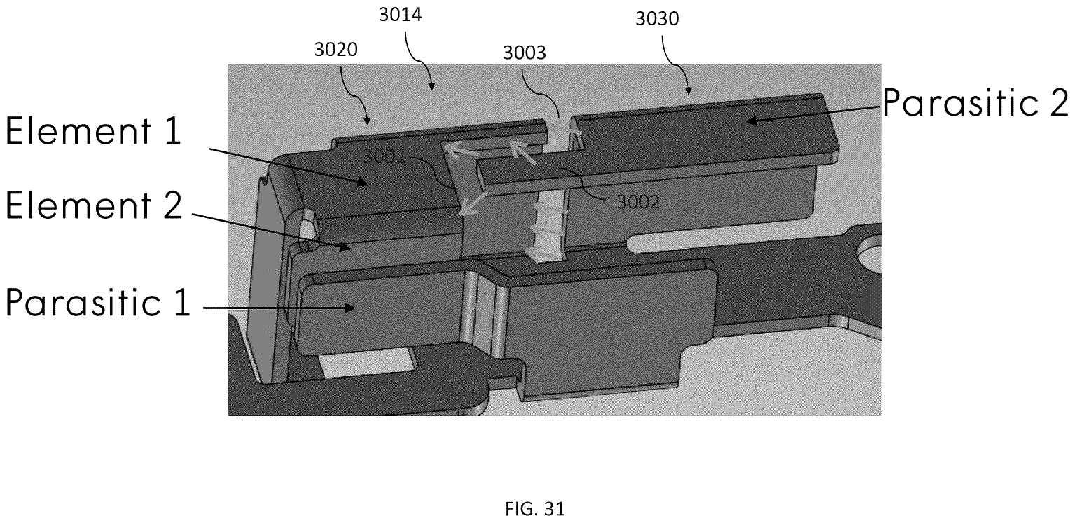

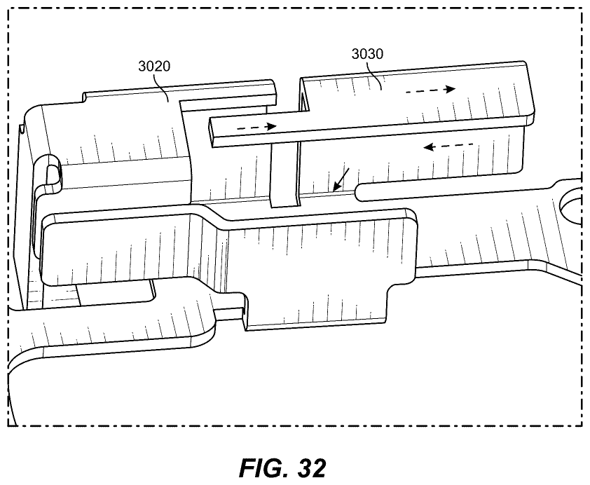

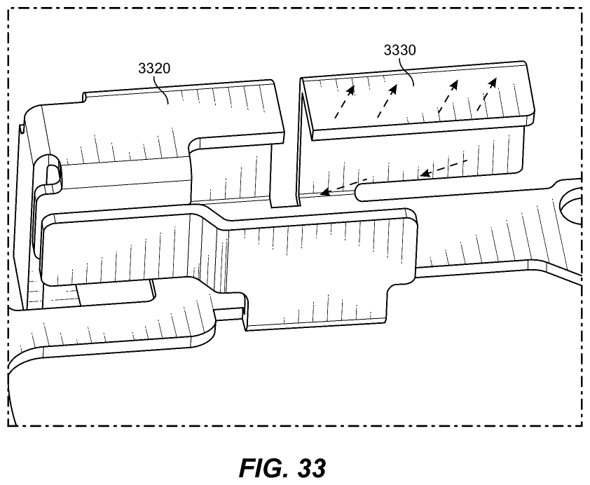

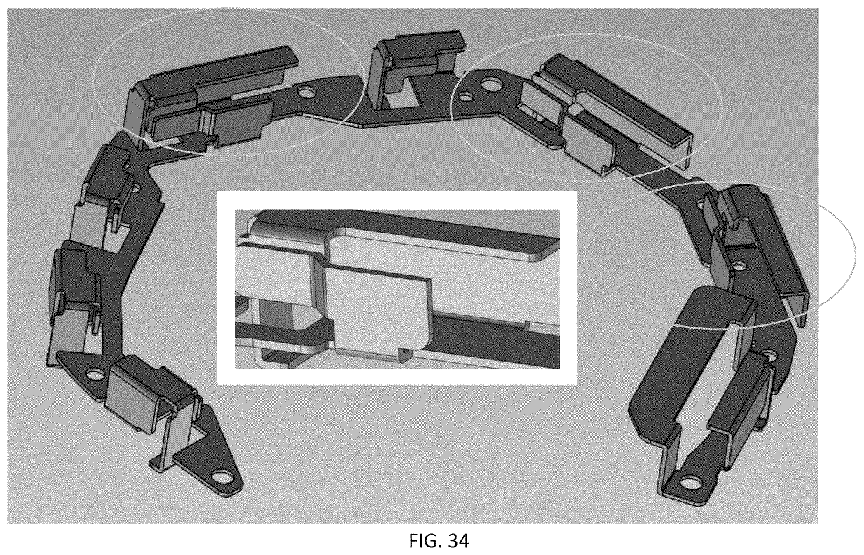

FIG. 30 shows an alternate configuration for antenna modules 3014, 3016, and 3017 on an antenna 3001 according to some embodiments. FIG. 31 shows a zoomed view of antenna module 3014, which is substantially similar to antenna modules 3016 and 3017 in this non-limiting example according to some embodiments. In some embodiments, one or more driven portions 3020 are formed with a recess 3001 configured to accommodate at least a portion of a projection 3002 from an adjacent parasitic portion 3030. As shown in FIG. 31, in some embodiments, the gap 3003 formed by the recess 3001 and the projection 3002 creates a longer current path for an open slot antenna radiation (arrows). FIG. 32 illustrates the current path (dashed arrow) along parasitic element 3030 for a non-limiting example configuration according to some embodiments. FIG. 33 illustrates the current path (dashed arrow) induced by driven portion 3320 along parasitic portion 3330 for another non-limiting example configuration according to some embodiments. In some embodiments, as depicted in FIG. 33, the different direction of the arrows (e.g., current) can influence resonance; and in some embodiments, such current flow can be along the edge. FIG. 34 shows yet another antenna module configuration according to some embodiments.

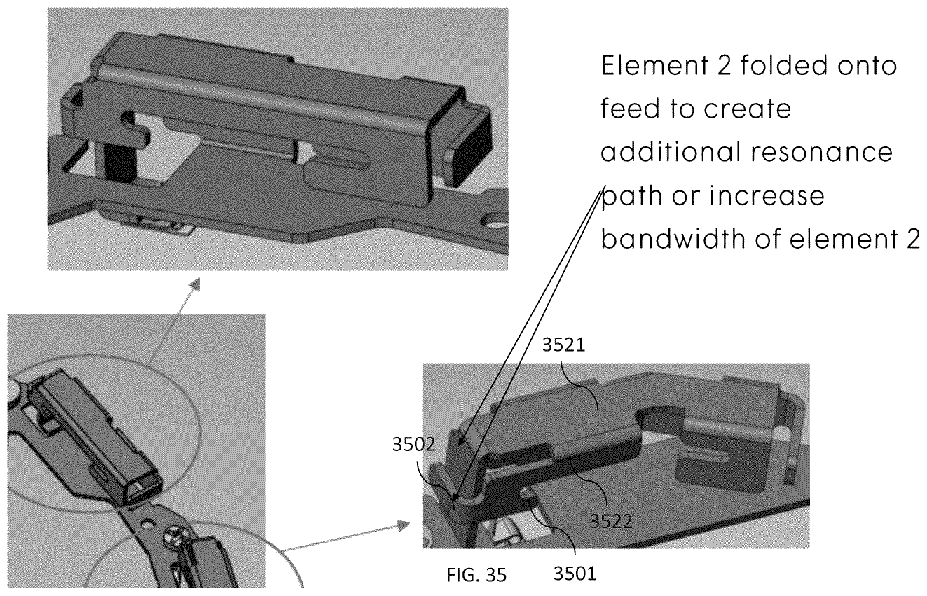

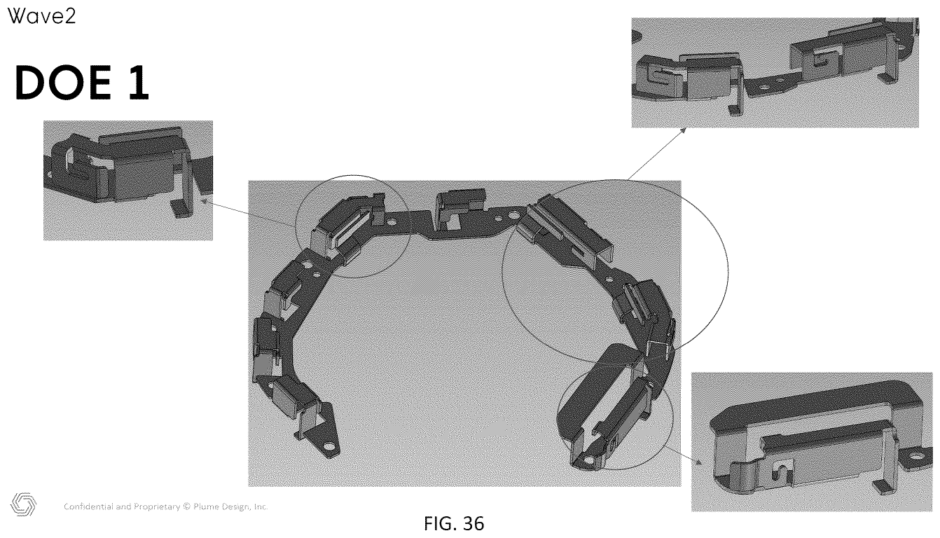

FIG. 35 illustrates forming a projection 3501 and/or a fold 3502 on a second driven element 3522 projecting from a first driven element 3521 according to some embodiments. In some embodiments, a projection and/or fold is configured to create an additional resonance path and/or increase the bandwidth of an element. In some embodiments, a method of manufacture includes forming (e.g., cutting) a continuous material such that at least a portion the continuous material forms a projection, gap, recess, slot, and/or fold on a driven and/or parasitic element when formed to a final shape to increase the bandwidth of at least one element. FIG. 36 illustrates various antenna configurations with various projections, folds, recess, and/or slots according to some embodiments.

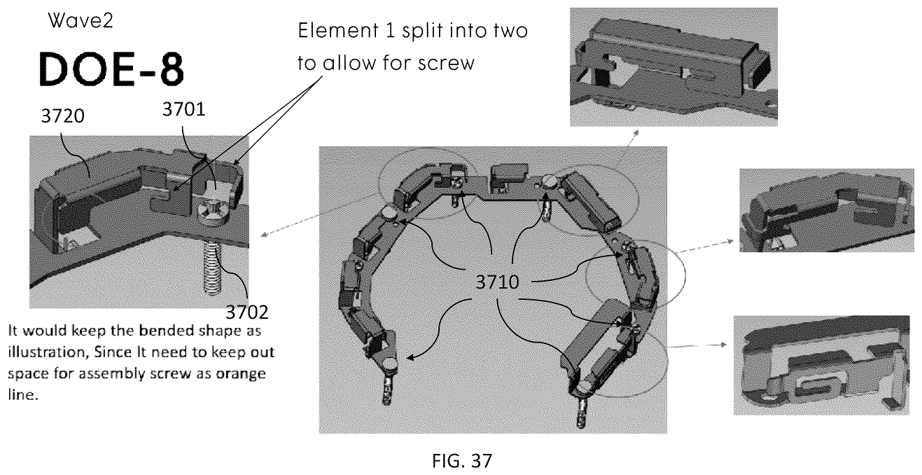

FIG. 37 illustrates a method of manufacture for forming a gap 3701 in one or more elements for a fastener 3702 while still providing desirable frequency resonance according to some embodiments. In some embodiments, the method of manufacture includes creating a gap 3701 in a driven portion 3720 and/or parasitic portion (not shown) large enough to fit a fastener (e.g., screw), where the fastener is configured to couple the antenna to the carrier. In some embodiments, the gap 3701 is configured to enable a withdrawal of the fastener 3702 without touching the driven portion 3720 and/or parasitic portion. In some embodiments, the driven portion 3720 and/or parasitic portion includes a split into at least two sections to accommodate the installation of a fastener when the antenna is positioned on top of the antenna carrier. In some embodiments, one or more projections and/or slots are formed from and/or around the gap to obtain desirable characteristics. FIG. 37 also illustrates various non-limiting example fastener hole configurations 3710, as well as other antenna module configurations according to some embodiments.

It is understood that any configuration presented herein is able to be described with words that are not recited verbatim in the written disclosure when defining the metes and bounds of the system. It should also be understood that a reference to a driven portion having a particular shape can also be applied to the parasitic portion having a similar shape in some embodiments, and vice versa.

It is further understood that the system is not limited in its application to the details of construction and the arrangement of components set forth in the previous description or illustrated in the drawings. The system and methods disclosed herein fall within the scope of numerous configurations according to some embodiments. The previous discussion is presented to enable a person skilled in the art to make and use embodiments of the system. Any portion of the structures and/or principles included in some embodiments can be applied to any and/or all embodiments: it is understood that features (e.g., projections, slots, recesses, etc.) from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable and/or incorporated into any description of the metes and bounds of the system. Any functional language in the drawings is a reference to the system being configured to perform the recited function, and structures shown or described in the drawings are to be considered as the system comprising the structures recited therein. It is understood that defining the metes and bounds of the system using a description of images in the drawing does not need a corresponding text description in the written specification to fall within the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean clement A alone, element B alone, or elements A and B together. In addition, a recitation of “at least one of A, B, and C,” a recitation of “at least one of A, B, or C,” or a recitation of “at least one of A, B, or C or any combination thereof” are each defined to mean clement A alone, element B alone, clement C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry including the continuous material described herein.

As used herein, “can” or “may” or derivations thereof (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function according to some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Any of the steps described herein that form part of the system are useful machine operations. The system also relates to a device or an apparatus for performing these operations. All programs presented herein represent computer implemented steps and/or are representations of at least a portion of algorithms implemented by the system. The computer can also perform other processing, program execution or routines that are not part of the special purpose, while still being capable of operating for the special purpose, which includes signal processing in non-limiting examples. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the system can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object and/or manipulation of the components of a conventional speaker to generate sound. In some embodiments, the manipulation can be performed by a processor. In such an example, the processor thus transforms the data from one thing to another. Still further, some embodiments include methods that can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method manufacturing and/or program operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the system has been described above in connection with particular embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

We claim:

1. An antenna assembly comprising:
an antenna formed from a continuous material;
wherein the antenna comprises a plurality of antenna modules;
wherein each the plurality of antenna modules includes a single feeder configured to receive a voltage; and
wherein each of the plurality of antenna modules is configured to resonate at a plurality of frequencies in response to a single voltage supplied through a respective single feeder.

2. The antenna assembly of claim 1,
wherein at least one antenna module of the plurality of antenna modules includes one or more driven elements and one or more parasitic elements.

3. The antenna assembly of claim 2,
wherein the one or more parasitic elements are configured and/or positioned to receive an induced voltage from at least one driven element.

4. The antenna assembly of claim 2,
wherein the one or more parasitic elements are configured to resonate at a different frequency than one or more driven elements.

5. The antenna assembly of claim 1,
further comprising an antenna carrier.

6. The antenna assembly of claim 5,
wherein at least a portion of the antenna carrier is configured to form at least part of an effective length for current resonance at a predetermined frequency.

7. An antenna comprising:
a plurality of driven elements and a plurality of parasitic elements formed from a single continuous material.

8. The antenna of claim 7,
wherein the antenna comprises a plurality of antenna modules formed from the single continuous material;
wherein each of the plurality of antenna modules comprises the plurality of driven elements and the plurality of parasitic elements.

9. The antenna of claim 8,
wherein one or more antennas formed by one or more antenna module configurations include an internal fractal antenna (IFA) and/or a planar inverted-f antenna (PIFA).

10. The antenna of claim 8,
wherein the plurality of parasitic elements are each configured to receive an induced voltage from a source other than a feeder.

11. The antenna of claim 8,
wherein one or more antennas formed by one or more antenna module configurations include one or more open-slot antennas.

12. The antenna of claim 8,
wherein one or more antennas formed by one or more antenna module configurations include one or more slot antennas.

13. A method of manufacturing an antenna comprising:
providing a continuous material;
processing the continuous material to generate a plurality of preformed shapes;
forming the plurality of preformed shapes into an antenna comprising a plurality of antenna modules; and
forming a single feeder from at least one preformed shape;
wherein each of the plurality of antenna modules is configured to resonate at a plurality of frequencies in response to a voltage received from the single feeder.

14. The method of claim 13, further including a step of:
folding one or more preformed shapes to create a first driven element.

15. The method of claim 13, further including a step of:
folding one or more preformed shapes to create a first parasitic element.

16. The method of claim 13, further including steps of:
folding one or more preformed shapes to create a gap between a first driven element and a first parasitic element.

17. The method of claim 13, further including a step of:
folding one or more preformed shapes to create a bridge between a first driven element and a first parasitic element.

18. The method of claim 13, further including a step of:
folding one or more preformed shapes to create a projection extending from a first driven element configured to extend a bandwidth of the first driven element.
